(19) United States
(12) Patent Application Publication
(10) Pub. No.: US 2014/0376912 A1
(43) Pub. Date: Dec. 25, 2014

(54) OPTICAL ACCESS NETWORK

(71) Applicants: Fabio Cavaliere, Pisa (IT); Emesto Ciaramella, San Giuliano Terme (PI) (IT); Luca Giorgi, Pisa (IT); Marco Presi, Peccioli (PI) (IT)

(72) Inventors: Fabio Cavaliere, Pisa (IT); Emesto Ciaramella, San Giuliano Terme (PI) (IT); Luca Giorgi, Pisa (IT); Marco Presi, Peccioli (PI) (IT)

(73) Assignee: Telefonaktiebolaget L M Ericsson (PUBL), Stockholm (SE)

(21) Appl. No.: 14/131,668

(22) PCT Filed: Jul. 8, 2011
(86) PCT No.: PCT/EP2011/061621

§ 371 Date: Aug. 21, 2014

(51) Int. Cl. H04Q 11/00; H04L 27/00; H04J 14/02

(52) U.S. Cl. CPC H04Q 11/0067; H04J 14/025; H04L 27/0008; H04J 2014/0253; H04Q 2011/0086; H04Q 2011/0016
USPC 398/49; 398/67

(57) ABSTRACT

An optical access network comprises an optical line terminal and an optical network unit having a transmitter. An optical path connects an output of the transmitter of the optical network unit to the optical line terminal. The transmitter of the optical network unit is arranged to transmit an upstream signal with an amplitude modulation format having at least one level transition per data bit period for at least one of the logical bits and a frequency modulation occurring with the level transition. An optical filter is positioned in the optical path. A central wavelength of a response of the optical filter has an offset with respect to a wavelength of the upstream signal. The wavelength of the upstream signal is located on a slope of the response of the optical filter.

### TECHNICAL FIELD

This invention relates to apparatus for use in an optical access network such as a Passive Optical Network (PON).

### BACKGROUND

Cost-effective solutions for a Wavelength Division Multiplexed Passive Optical Network (WDM PON) have been proposed, based on re-use of a same wavelength for downstream and upstream transmission.

One proposal is to use a Reflective Semiconductor Optical Amplifier (R-SOA) as a colourless transmitter at the ONU. Part of the downstream signal is tapped and sent to the R-SOA input. In a paper “A 80 km reach fully passive WDM-PON based on reflective ONUs”, Presi et al, Optics Express, vol. 16, no. 23, pp 19043-19048, 10 Nov. 2008 Return to Zero (RZ) and Inverse Return to Zero (IRZ) modulation formats are used for upstream and downstream transmission, respectively. An R-SOA at the ONU remodulates and amplifies a seed portion of a received downstream IRZ signal to generate an RZ upstream data signal.

A problem with this type of system is that it is not able support data rates higher than 2.5 Gbit/s.

A paper “Error-Free All-Optical Wavelength Conversion at 160 Gb/s Using a Semiconductor Optical Amplifier and an Optical Bandpass Filter”, Y. Liu et al, Journal of Lightwave Technology, Vol. 24, No. 1, January 2006, describes a wavelength converter utilising a Semiconductor Optical Amplifier (SOA) with a recovery time greater than 90 ps and an optical bandpass filter (OBF) placed at the amplifier output. The paper shows that an OBF with a central wavelength that is blue shifted compared to the central wavelength of the converted signal shortens the recovery time of the wavelength converter to 3 ps.

A paper “Investigation of 10-Gb/s R-SOA-Based Upstream Transmission in WDM-PONs Utilizing Optical Filtering and Electronic Equalization”, Papagiannakis et al, IEEE Photonics Letters, Vol. 20, No. 24, Dec. 15, 2008, describes enhanced transmission at 10 Gb/s using a low-bandwidth RSO and an offset optical bandpass filter. The system architecture proposed is a seeded WDM PON where an OLT supplies a continuous wave (CW) downstream signal to an ONU. The upstream signal from the ONU is Non-return-to-zero (NRZ) coded.

### SUMMARY

An aspect of the invention provides an apparatus for an optical access network. The optical access network comprises an optical line terminal. The apparatus comprises an optical network unit having a transmitter. The apparatus further comprises an optical path for connecting an output of the transmitter of the optical network unit to the optical line terminal. The transmitter of the optical network unit is arranged to transmit an upstream signal with an amplitude modulation format having at least one level transition per data bit period for at least one of the logical bits and a frequency modulation occurring with the level transition. The optical path further comprises an optical filter positioned in the optical path. A central wavelength of a response of the optical filter has an offset with respect to a wavelength of the upstream signal. The wavelength of the upstream signal is located on a slope of the response of the optical filter.

The optical filter allows the transmitter to operate at a higher bit rate than would normally be expected, due to co-operation between the frequency modulation of the upstream signal and the response of the optical filter. The frequency modulation will be called “chirp” in this specification.

The amplitude modulation format has frequent level transitions. Therefore, the transmitter will frequently apply positive frequency modulation and negative frequency modulation (chirp) to the transmitted signal. This can reduce the coherence time of the transmitted signal and can reduce cross-talk with a downstream signal. This has an advantage of making it possible to use the same wavelength for downstream communication and upstream communication. Advantageously, the amplitude modulation format is Return-to-Zero (RZ) which applies two level transitions, and hence two chirps, for each logical “1” of the transmitted signal.

The optical filter can be an optical bandpass filter, with a central wavelength of a pass-band of the optical filter having a blue-shift offset with respect to a wavelength of the upstream signal. Alternatively, the optical filter can be an optical bandstop filter, with a central wavelength of a stop-band of the optical filter having a red-shift offset with respect to a wavelength of the upstream signal.

The optical filter can have a pass-band matched to a wavelength used by the optical network unit. The optical filter can be positioned in an optical link only serving the optical network unit. This arrangement has an advantage of combining the offset filter with a channel filtering function.

The apparatus can comprise a plurality of optical network units, each having an optical path for connecting an output of the transmitter of the optical network unit to an optical line terminal. The optical bandpass filter can be positioned in a part of the optical access network carrying signals from a plurality of optical network units. The optical bandpass filter can comprise a filter having a plurality of pass-bands, wherein a central wavelength of a pass-band of each optical filter has an offset with respect to a respective wavelength of the upstream signal serving each optical network unit, with the wavelength of the upstream signal located on a slope of the response of the optical filter. This has an advantage of reducing the number of filters required in the optical access network.

The optical filter can be positioned in an optical link carrying a plurality of wavelength channels between a distribution node and a distribution node.

The optical filter can be a comb filter.

The optical access network can comprise a distribution node comprising a power splitting function. The optical access network can further comprise a further optical filter having a pass-band matched to a wavelength used by the optical line terminal. The further optical filter is positioned in an optical link only serving the optical line terminal.

The optical filter can be positioned at a distribution node which connects to the plurality of optical network units.

The optical filter can be positioned at a wavelength multiplexer which connects to a plurality of optical line terminals operating at different wavelengths.

The optical filter can comprise an arrayed waveguide grating.

The optical network unit can be arranged to receive a downstream signal and to transmit the upstream signal by using at least a portion of the downstream signal.

The optical network unit can be arranged to receive a data-carrying downstream signal and to transmit the upstream signal by using at least a portion of the data-carrying downstream signal.

The transmitter can be arranged to receive a downstream seed signal at the same wavelength as the upstream signal.

Advantageously, the apparatus further comprises a receiver at the optical network unit. The receiver is arranged to receive a downstream signal at the same wavelength as the upstream signal. The downstream signal can be modulated with data.

Advantageously, the transmitter is a Reflective Semiconductor Optical Amplifier or an Electro-Absorption Modulator.

Another aspect of the invention provides a method of transmitting an upstream signal in an optical access network. The optical access network comprises an optical line terminal, an optical network unit and an optical path connecting a transmitter of the optical network unit to the optical line terminal. The method comprises transmitting an upstream signal from the optical network unit with an amplitude modulation format having at least one level transition per data bit period for at least one of the logical bits and a frequency modulation occurring with the level transition. The method further comprises filtering the upstream signal at an optical filter positioned in the optical path. A central wavelength of a response of the optical filter has an offset with respect to a wavelength of the upstream signal. The wavelength of the upstream signal is located on a slope of the response of the optical filter.

### BRIEF DESCRIPTION OF THE DRAWINGS

Embodiments of the invention will be described, by way of example only, with reference to the accompanying drawings in which:

FIG. 1 shows an optical access network;

FIGS. 2A and 2B show apparatus at an Optical Network Unit (ONU) of the network of FIG. 1;

FIG. 3 shows intensity and frequency responses of a signal transmitted by an ONU;

FIGS. 4A and 4B each show a response of a filter which is offset from the wavelength used for upstream communication;

FIG. 5 shows an optical access network with an offset filter positioned near an ONU;

FIG. 6 shows an optical access network with a comb offset filter positioned near OLTs;

FIG. 7 shows an optical access network with an offset filter positioned near an ONU and a channel filter positioned near an ONU;

FIG. 8 shows an optical access network with an offset filter incorporated in a wavelength router at a distribution node;

FIG. 9 shows an optical access network with an offset filter incorporated in a wavelength router near OLTs;

FIG. 10 shows an optical access network with a comb offset filter positioned near the distribution node;

FIG. 11 shows a method of operating transmitter apparatus in an optical access network.

### DETAILED DESCRIPTION

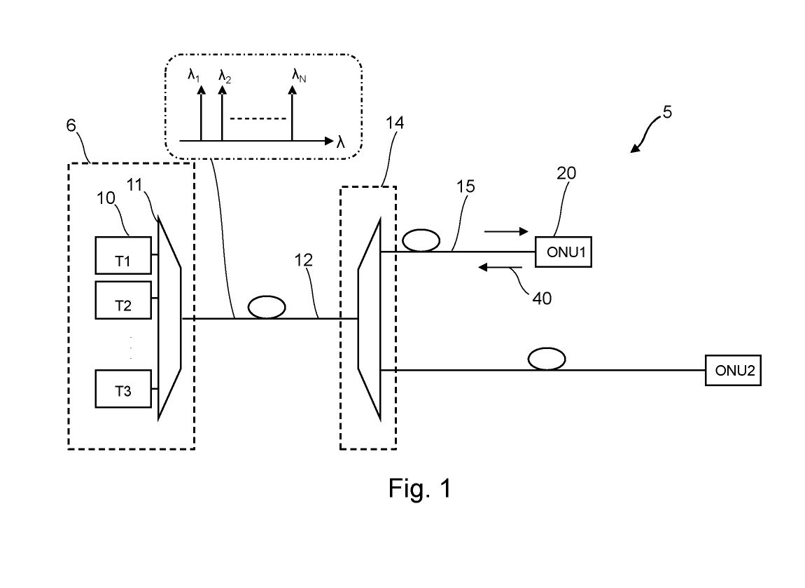

FIG. 1 shows an optical access network 5 according to an embodiment of the invention. An Optical Line Terminal (OLT) 10 connects to an Optical Network Unit (ONU) 20 via an optical path. The optical path between the OLT 10 and ONU 20 can comprise a distribution node 14 (also called a remote node) which connects to a plurality of ONUs 20. A trunk fibre 12 connects the OLT 10 to the distribution node 14. Typically, there is a single fibre 15 between the distribution node 14 and ONU 20 for each ONU 20. The ONU 20 terminates the optical path of the access network. An ONU can be installed at a subscriber premises, such as a home or business premises. This scenario is typically called Fibre To The Home (FTTH) or Fibre To The Premises (FTTP). Alternatively, an ONU can be installed at a unit which serves a plurality of premises. A unit can be positioned at a streetside cabinet or can serve an apartment building. This scenario is typically called Fibre To The Node (FTTN), Fibre To The Curb (FTTC), Fibre To The Cabinet (FTTCab) or Fibre To The Building (FTTB).

A plurality of OLTs 10 are provided at a node 6 for communicating with ONUs 20 deployed in the access network. A multiplexer/demultiplexer 11 is provided. In the downstream direction (towards ONUs 20), multiplexer/demultiplexer 11 combines signals output by OLTs 10 for forwarding along trunk fibre 12 to the distribution node 14. In the upstream direction, (towards OLTs 10) multiplexer/demultiplexer 11 demultiplexes signals received from the distribution node 14 and forwards them to OLTs 10. OLTs 10 connect to one or more operator networks (not shown).

The overall network 5 is typically called a Passive Optical Network (PON) because the optical transmission has no power requirements, or limited power requirements, once an optical signal is travelling through the network section connecting the ONU to the OLT.

The access network 5 can be a Wavelength Division Multiplexed Passive Optical Network (WDM-PON). A set of optical wavelength carriers are used to serve ONUs. Each ONU 20, 30 can be served by a different wavelength carrier. The wavelength carriers are also called wavelength channels, or lambdas (λ), and the term lambdas will be used in the following description. In the downstream direction, distribution node 14 demultiplexes lambdas received on trunk fibre 12 and outputs lambdas on different ones of the fibres 15, such that a single lambda is forwarded from RN 14 to an ONU 20 which uses that lambda. In the upstream direction, distribution node 14 receives lambdas on the plurality of fibres 15, multiplexes them, and outputs the multiplexed combination of lambdas on trunk fibre 12.

There are various possibilities for bi-directional communication. In one advantageous scheme, a single lambda is provided for downstream and upstream communication between an OLT 10 and ONU 20. The OLT 10 modulates the lambda with an Inverse Return-to-Zero (IRZ) modulation format in the downstream direction and ONU 20 modulates the lambda with a Return-to-Zero (RZ) modulation format in the upstream direction. The ONU 20 can use a device such as a Reflective Semiconductor Optical Amplifier (R-SOA) or a Reflective Electro-Absorption Modulator (R-EAM) to reflect, and amplify, a portion of the optical signal received on the downstream. This scheme has an advantage of using only one lambda per ONU.

Another possible scheme is that separate lambdas are used for downstream and upstream directions of communication. The upstream signal can be generated by an optical source at an ONU 20, or it can be “seeded” to the ONU 20 by transmitting a continuous wave (CW) signal to the ONU. The ONU 20 can amplify and modulate the signal for upstream communication using a device such as R-SOA or R-EAM.

Advantageously, in any of the schemes, the transmitter at the ONU 20 is a colourless transmitter. This means that the transmitter can operate at a range of operating lambdas and is not tied to a particular operating lambda. This has an advantage that the one type of device can be manufactured on an economic scale for use in any ONU.

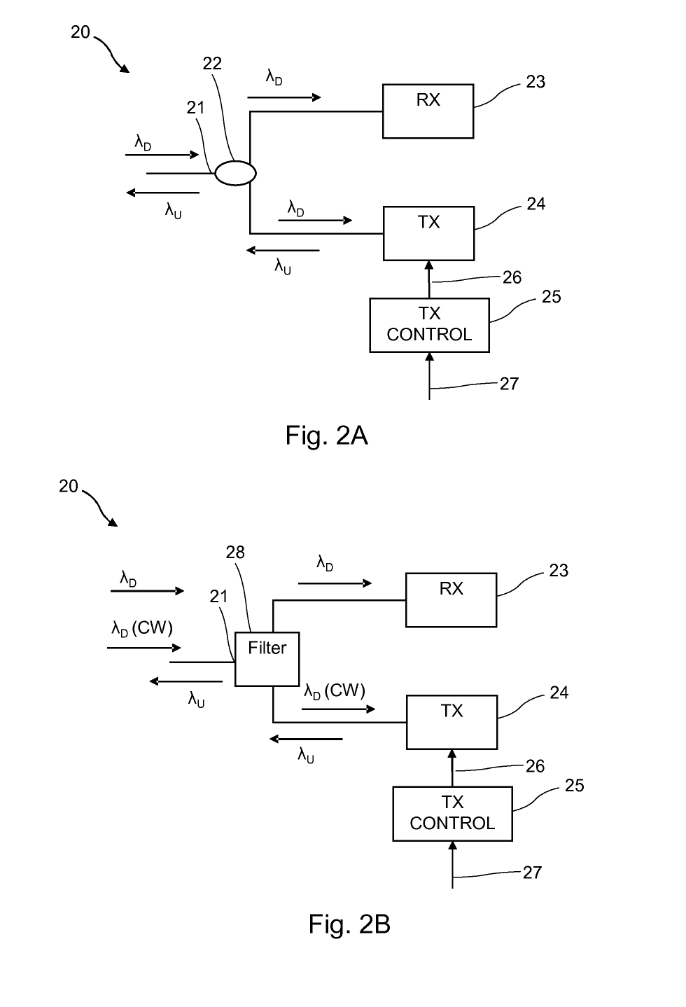

FIG. 2A shows an embodiment of apparatus at an optical network unit (ONU) 20. ONU 20 comprises a transmitter 24 such as a reflective semiconductor optical amplifier (R-SOA) and a driver 25 arranged to generate a drive signal 26 to drive the R-SOA. The R-SOA is arranged to receive a portion of a downstream optical signal. The label λ_{D} is used to represent lambda of a downstream signal and the label λ_{U} is used to represent lambda of an upstream signal. As described above, in one advantageous embodiment λ_{D}=λ_{U}.

The downstream optical signal is delivered to an optical input of the ONU 20 and a portion of the downstream optical signal is routed to the R-SOA 24 by an optical splitter 22. The downstream optical signal has a signal wavelength and a signal power. The driver 25 is arranged to generate the drive signal 26 to cause the R-SOA to apply a return-to-zero (RZ) line code to the portion of the downstream optical signal received at the R-SOA to form an upstream optical signal at the signal wavelength.

Return-to-zero (RZ) line coding is one example of a modulation format that emphasises the chirp effects. It is a line coding format that has a transition in logical level. Other formats could be used, such as Manchester coding.

FIG. 2B shows another embodiment of apparatus at an optical network unit (ONU) 20. The apparatus is the same as shown in FIG. 2A. A signal λ_{D} (CW) is provided as a seed signal for the ONU 20. The downstream signal is an unmodulated continuous wave signal. The seed signal is amplified and modulated by the R-SOA 24. A separate downstream signal at a different wavelength is used to carry downstream data to the ONU 20, i.e. λ_{D} (CW)≠λ_{D}. A filter 28 is placed in the receive path to block the seed signal λ_{D} (CW).

In any of the embodiments, the R-SOA can be replaced by a device such as a Semiconductor Optical Amplifier (SOA), a R-EAM or an EAM.

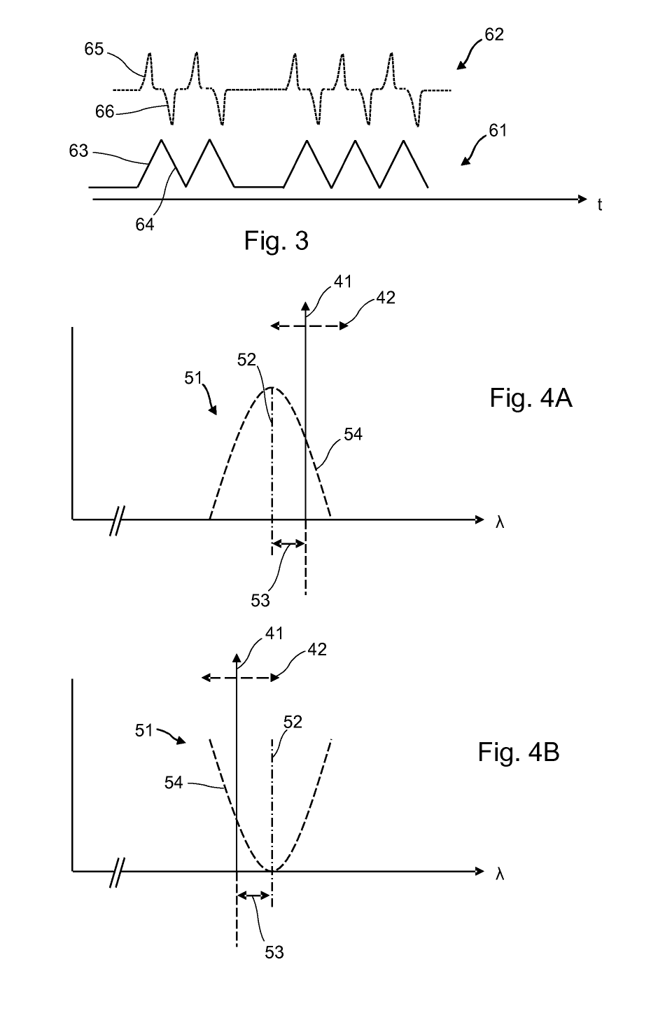

FIG. 3 shows an example of a transmitted signal. An intensity of the signal versus time is shown as response 61. Response 62 shows the corresponding frequency variations over the same time period. Signal 61 is modulated with a Return-to-Zero (RZ) modulation scheme. A similar property arises with a device such as a SOA, EAM or R-EAM. For each logical “1” in the transmitted data, the transmitter transmits a rising pulse edge 63 and a falling pulse edge 64. The intensity always returns to zero, even if the subsequent data bit is also a logical “1”. A property of the R-SOA is that the transmitted signal has frequency modulation, called chirp, applied to it when there is a change in intensity level. The transmitted RZ modulated signal is highly chirped. For each logical “1” in the transmitted data, there is a positive frequency chirp 65 (i.e. blue-shift) and a negative frequency chirp (i.e. red-shift). The chirped response helps to reduce coherence time, and can allow high data rate transmission (e.g. at 10 Gb/s) and use of a single lambda for downstream and upstream communication.

Optionally, in addition to the frequency modulation (chirp) that arises when there is a change in intensity level, the driver 25 can be arranged to generate a drive signal 26 which causes the R-SOA to apply an additional phase/frequency modulation to the upstream optical signal.

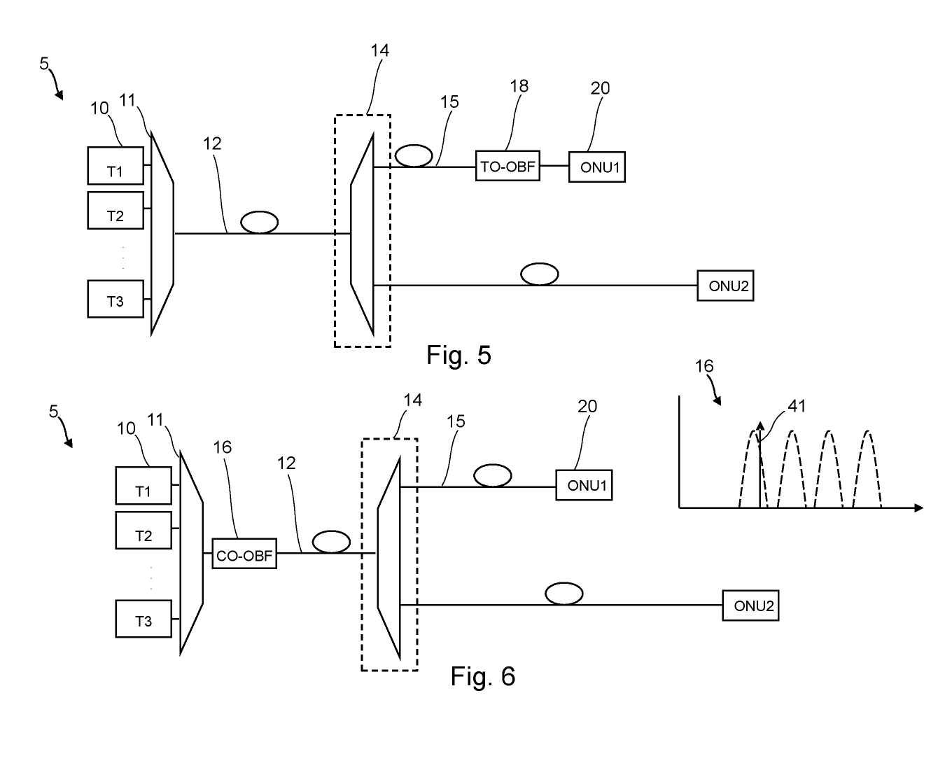

FIGS. 5 to 10 show various embodiments of apparatus for the optical access network 5. In each of these embodiments, an optical filter is positioned at some point along the optical path between the transmitter in the ONU 20 and a receiver in the OLT 10. The central wavelength of the filter response is shifted with respect to that of the wavelength used for upstream communication.

FIG. 4A shows an optical bandpass filter (OBF) which can be used in the arrangements of FIGS. 4 to 9. The optical bandpass filter (OBF) has a transmissive response 51. The response 51 has a central wavelength 52 at which the response has a maximum value and a slope on each side of the central wavelength 52. Typically the response of the filter will be symmetrical about the central wavelength 52, but the response does not have to be symmetrical, and the term “central wavelength” is intended to mean the wavelength where the response is greatest.

A wavelength 41 used for upstream data transmission in network 5 is located on a slope 54 of the pass-band response 51. Wavelength 41 is offset, on the higher wavelength side, from the central wavelength 52 of the response. Stated another way, the central wavelength of the pass-band 51 of the optical filter has a blue-shift offset 53 with respect to a wavelength 41 of the upstream signal.

The offset of the wavelength 41 of the upstream signal has the effect of enhancing the response of the upstream signal. A full description of the principle by which the response of the R-SOA can be enhanced is given in the Liu paper referenced above. A summary will now be given. The upstream signal experiences a frequency modulation, called chirp, on the rising and falling edges of a pulse. This movement about the nominal upstream wavelength is shown by arrow 42.

During the rising time of a pulse, the transmitted signal experiences frequency modulation which moves the transmitted frequency moves toward shorter wavelengths (blue shift). This moves the signal towards the left of FIG. 4A (reduced filter attenuation). This makes the pulse rising edge steeper due to the reduced attenuation of the filter.

During the fall time of a pulse, the transmitted signal experiences frequency modulation which moves the transmitted frequency moves toward longer wavelengths (red shift). This moves the signal towards the right of FIG. 4A (increased filter attenuation). This makes the pulse falling edge steeper, due to the additional attenuation introduced by the filter.

FIG. 4A shows an optical bandpass filter. It is also possible to use an optical bandstop filter in a similar manner, as shown in FIG. 4B. Similar reference numerals are used to indicate similar features of the filter response. A wavelength 41 used for upstream data transmission in network 5 is located on a slope 54 of the stop-band response 51. Wavelength 41 is offset, on the lower wavelength side, from the central wavelength 52 of the response. Stated another way, the central wavelength of the stop-band 51 of the optical filter has a red-shift offset 53 with respect to a wavelength 41 of the upstream signal.

The offset 53 can be any suitable offset which positions the wavelength 41 on a part of the slope 54 of the filter response where there the pulse steepening effect will be achieved. A possible position is the filter 3 dB point (i.e. 3 dB from peak).

FIG. 5 shows an arrangement with an offset channel filter TO-OBF 18 placed in the optical path 15, before the ONU. The channel filter can be a Tunable Offset Optical Bandpass Filter (T-OBF). The filter 18 is of the type described above, and shown in FIG. 4A. The central wavelength is shifted with respect to that of the wavelength 41 used for upstream communication. The filter has two functions: (i) it enhances the R-SOA bandwidth, and (ii) selects one wavelength channel from the WDM spectrum. This second function is useful when a power splitter is used at the distribution node 14, for compatibility with legacy PON infrastructure.

FIG. 6 shows an arrangement with a Comb Offset Optical Bandpass Filter CO-OBF 16 placed downstream of the OLTs 10 and of the multiplexer/demultiplexer 11. The CO-OBF can be realised as a Fibre Bragg Grating (FBG) or a Fabry Perot Filter (FPF). The central frequencies of the comb filter 16 are shifted with respect to those of the wavelengths 41 used for upstream communication, in order to enhance the bandwidth of the ONUs. An example response of the comb filter is also shown in FIG. 6. Optionally, the filter can also compensate for the fiber chromatic dispersion. This arrangement has the advantage of one filter for multiple wavelength channels. A single comb filter can be provided for all wavelength channels.

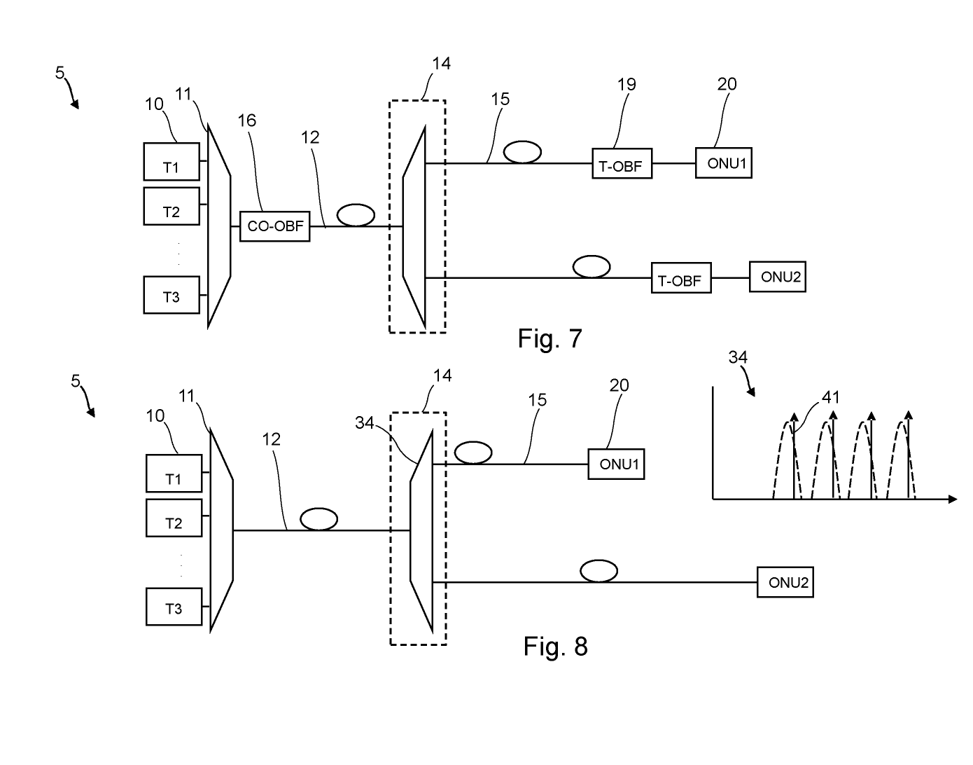

FIG. 7 shows a similar arrangement to FIG. 5, with an offset comb filter CO-OBF 16 positioned downstream of the multiplexer/demultiplexer 11. A power splitter is used at the distribution node 14. As a power splitter does not have a wavelength filtering function, channel filters T-OBF 19 are positioned in the part of the optical path 15 between the distribution node 14 and ONU 20. The channel filter can be a Tunable Optical Bandpass Filter (T-OBF). Filter 19 does not have to be offset from the wavelength used to carry the upstream signal, as this function has already been performed by comb filter CO-OBF 16.

FIG. 8 shows an arrangement in which no additional filters are required. A wavelength router, such as an Arrayed Waveguide Grating (AWG), is provided at the distribution node 14. Conventionally, the AWG has pass bands matched to the channel wavelengths. Modified AWG 34 has passbands which are offset with respect to the wavelengths of the channels. Each wavelength 41 used for upstream communication is positioned on a slope of one of the pass-bands.

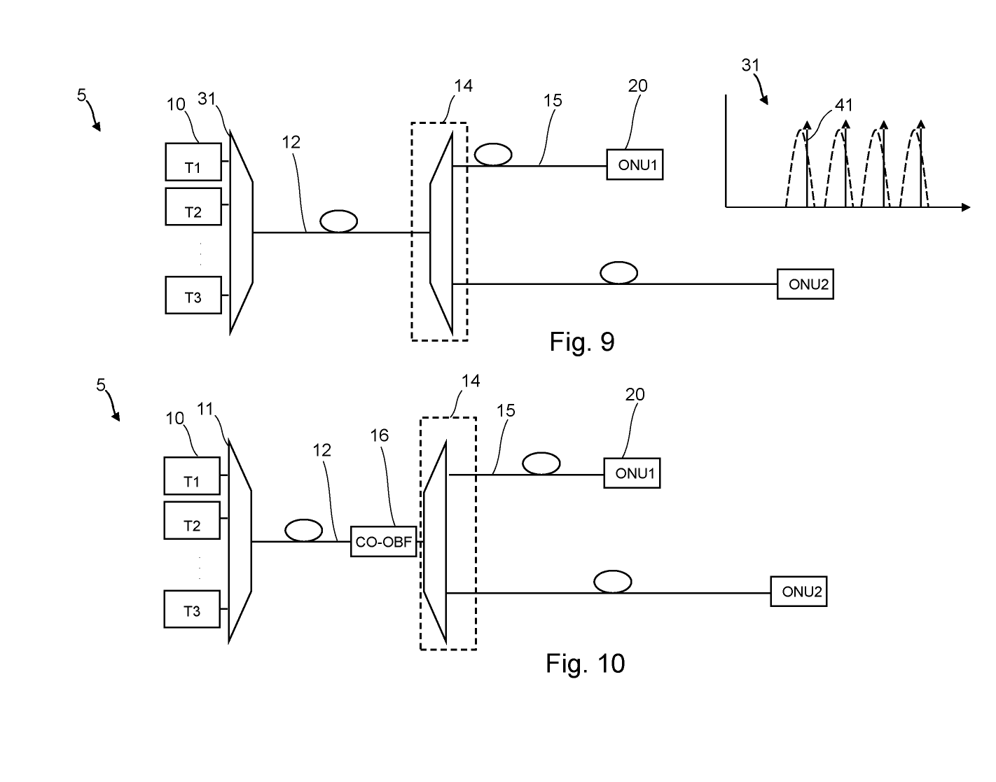

FIG. 9 shows a similar arrangement to FIG. 8. Conventionally, a demultiplexer 11 has a wavelength routing function. In the upstream direction, it demultiplexes channel wavelengths and applies each channel wavelength to an OLT 10. The demultiplexer can be a device such as an AWG. Similar to FIG. 7, the modified demultiplexer 34 has a response in which pass-bands are offset with respect to the channel wavelengths. Each wavelength 41 used for upstream communication is positioned on a slope of one of the pass-bands. FIGS. 7 and 8 are the lowest cost options, as no additional filters are required in the optical paths, thereby saving cost of parts and installation of the parts in the access network.

FIG. 10 shows an arrangement similar to FIG. 6. The comb filter CO-OBF 16 is positioned at the distribution node 14.

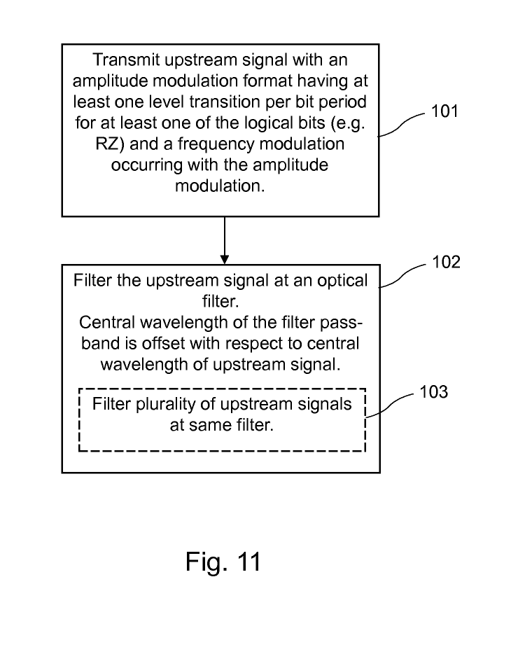

FIG. 11 shows a method of transmitting an upstream signal in an optical access network. The method comprises a step 101 of transmitting an upstream signal from the optical network unit with a chirp applied to the signal and a modulation format which has at least one transition in level per data bit period for at least one of the logical bits (e.g. RZ).

In any of the network arrangements shown in FIGS. 5 to 10 the optical filter having a bandpass response (FIG. 4A) can be replaced by an optical filter having a bandstop/notch response (FIG. 4B).

The method also comprises a step 102 of filtering the upstream signal at an optical filter positioned in the optical path. A central wavelength of a response of the optical filter has an offset with respect to a wavelength of the upstream signal. The wavelength of the upstream signal is located on a slope of the response of the optical filter.

Optionally, the method can comprise filtering a plurality of upstream signals of different wavelengths at the same filter.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. Apparatus for an optical access network, the optical access network comprising an optical line terminal, the apparatus comprising:
an optical network unit having a transmitter; and
an optical path for connecting an output of the transmitter of the optical network unit to the optical line terminal;
wherein the transmitter of the optical network unit is configured to transmit an upstream signal with an amplitude modulation format having at least one level transition per data bit period for at least one of the logical bits and a frequency modulation occurring with the level transition,
and wherein the optical path further comprises an optical filter positioned in the optical path, and wherein a central wavelength of a response of the optical filter has an offset with respect to a wavelength of the upstream signal, with the wavelength of the upstream signal located on a slope of the response of the optical filter.

2. Apparatus according to claim 1, wherein the optical filter has a pass-band matched to a wavelength used by the optical network unit and the optical filter is positioned in an optical link only serving the optical network unit.

3. Apparatus according to claim 1, further comprising a plurality of optical network units, each having an optical path for connecting an output of the transmitter of the optical network unit to an optical line terminal and wherein the optical bandpass filter is positioned in a part of the optical access network carrying signals from a plurality of optical network units, the optical bandpass filter comprising a filter having a plurality of pass-bands, wherein a central wavelength of a pass-band of each optical filter has an offset with respect to a respective wavelength of the upstream signal serving each optical network unit, with the wavelength of the upstream signal located on a slope of the response of the optical filter.

4. Apparatus according to claim 3, wherein the optical filter is positioned in an optical link carrying a plurality of wavelength channels between a distribution node and a distribution node.

5. Apparatus according to claim 4, wherein the optical filter is a comb filter.

6. Apparatus according to claim 3, wherein the optical access network comprises a distribution node comprising a power splitting function and the optical access network further comprises a further optical filter having a pass-band matched to a wavelength used by the optical line terminal, the further optical filter being positioned in an optical link only serving the optical line terminal.

7. Apparatus according to claim 3, wherein the optical filter is positioned at one of:
a distribution node which connects to the plurality of optical network units; and
a wavelength multiplexer which connects to a plurality of optical line terminals operating at different wavelengths.

8. Apparatus according to claim 7, wherein the optical filter comprises an arrayed waveguide grating.

9. Apparatus according to claim 1, wherein the optical network unit is configured to receive a downstream signal and to transmit the upstream signal by using at least a portion of the downstream signal.

10. Apparatus according to claim 9, wherein the optical network unit is configured to receive a data-carrying downstream signal and to transmit the upstream signal by using at least a portion of the data-carrying downstream signal.

11. Apparatus according to claim 1, wherein the transmitter is configured to receive a downstream seed signal at the same wavelength as the upstream signal.

12. Apparatus according to claim 1, further comprising a receiver at the optical network unit which is configured to receive a downstream signal at the same wavelength as the upstream signal, wherein the downstream signal is modulated with data.

13. Apparatus according to claim 1, wherein the transmitter of the optical network unit is configured to transmit the upstream signal with a return-to-zero modulation format.

14. Apparatus according to claim 1, wherein the optical filter is one of:
an optical bandpass filter wherein a central wavelength of a pass-band of the optical filter has a blue-shift offset with respect to a wavelength of the upstream signal; and
an optical bandstop filter wherein a central wavelength of a stop-band of the optical filter has a red-shift offset with respect to a wavelength of the upstream signal.

15. Apparatus according to claim 1, wherein the transmitter is one of: a Reflective Semiconductor Optical Amplifier; and an Electro-Absorption Modulator.

16. A method of transmitting an upstream signal in an optical access network, the optical access network comprising an optical line terminal, an optical network unit and an optical path connecting a transmitter of the optical network unit to the optical line terminal, the method comprising:
transmitting an upstream signal from the optical network unit with an amplitude modulation format having at least one level transition per data bit period for at least one of the logical bits and a frequency modulation occurring with the level transition; and
filtering the upstream signal at an optical filter positioned in the optical path, wherein a central wavelength of a response of the optical filter has an offset with respect to a wavelength of the upstream signal, with the wavelength of the upstream signal located on a slope of the response of the optical filter.

17. A method according to claim 16, wherein the optical access network serves a plurality of optical network units and the optical bandpass filter is positioned in a part of the optical access network carrying signals from a plurality of optical network units and the filtering comprises filtering a plurality of upstream signals by an optical bandpass filter having a plurality of pass-bands, wherein a central wavelength of a pass-band of each optical filter has an offset with respect to a respective wavelength of the upstream signal serving each optical network unit, with the wavelength of the upstream signal located on a slope of the pass-band of the optical filter.

18. A method according to claim 17, wherein the filtering is performed at one of:
a distribution node which connects to the plurality of optical network units; and
a wavelength multiplexer which connects to a plurality of optical line terminals operating at different wavelengths.
